(19) United States
(12) Patent Application Publication
(10) Pub. No.: US 2026/0114619 A1
(43) Pub. Date: Apr. 30, 2026

(54) BACK PANEL BRACKET SYSTEM

(71) Applicant: The Stow Company, Holland, MI (US)

(72) Inventors: Bryon Will, Holland, MI (US); Nathan Edwards, Hudsonville, MI (US)

(73) Assignee: The Stow Company, Holland, MI (US)

(21) Appl. No.: 19/368,168

(22) Filed: Oct. 24, 2025

Related U.S. Application Data
(60) Provisional application No. 63/712,178, filed on Oct. 25, 2024.

(51) Int. Cl. A47B 96/20; F16B 5/02; F16B 12/14

(52) U.S. Cl. CPC A47B 96/20; F16B 5/02; F16B 12/14

(57) ABSTRACT

A back panel bracket system for securing one or more inset back panels to vertical supports in storage systems such as closets, cabinets, and other storage structures is provided. The back panel bracket system comprises one or more back panel plates, each having a first short edge opposite a second short edge, a first long edge, and a second long edge, with wing portions extending from the long edges. The back panel plates are configured to secure back panels to both end vertical supports and shared vertical supports, providing easy alignment and gap-free installation, even when wall surfaces are uneven. The system reduces the number of components required for installation and ensures precise, secure attachment of the back panels to the vertical supports, facilitating efficient and professional assembly of storage systems.

### CROSS REFERENCE TO RELATED APPLICATIONS

This application claims benefit of U.S. Provisional Application No. 63/712,178 filed on October 25, 2024, and entitled BACK PANEL PLATE, which is hereby incorporated by reference in its entirety.

### TECHNICAL FIELD

The present disclosure generally relates to support systems for closets, cabinets, and other storage structures, and more particularly a back panel bracket system for use in securing back panels to vertical supports.

### BACKGROUND

Various systems for securing back panels to vertical supports in closets, cabinets, and storage systems are well-known in the art. Conventional methods for attaching back panels often result in gaps between the back panel and vertical supports or misalignments due to irregularities in wall surfaces or challenges in aligning screw holes. Additionally, many existing systems require different components depending on whether the bracket is used on an end vertical supports (vertical supports located at the ends of a storage system) or shared vertical supports (middle supports shared between adjacent sections of the storage system). This complicates the installation process and increases the number of parts needed to complete a full system installation.

As such, there is a need for a back panel bracket system that can be used on both end and shared vertical supports, facilitating faster and more accurate installation of back panels in closets, cabinets, and other storage systems. Such a system would reduce the number of component parts required for installation, ensure consistent alignment of screw holes on vertical supports, and provide a secure, gap-free fit between the back panel and the supports, even when the wall surface is uneven.

### BRIEF SUMMARY OF THE INVENTION

The present disclosure is directed to a back panel bracket system for use in securing back panels to vertical supports in storage systems for closets, cabinets, and other storage areas with a desired level of organizational structure. According to one embodiment of the invention, the back panel bracket system may comprise one or more back panel plates, one or more end vertical supports, and one or more back panels. In other embodiments, the back panel bracket system may also comprise one or more shared vertical supports.

The present disclosure further provides a method of aligning and securing back panels to vertical supports in storage systems. The method may comprise the following steps: providing one or more back panel plates adapted to secure the one or more back panels to the one or more vertical supports; positioning the first back panel plate in contact with a first end vertical support; securing the first back panel plate to the first end vertical support; positioning a second back panel plate in contact with a second end vertical support; securing the second back panel plate to the second end vertical support; positioning a shared vertical support between the first and second end vertical supports; securing a third back panel plate to the shared vertical support; positioning a first back panel between the top shelf and the bottom shelf, such that the first back panel is aligned with the first back panel plate on the first end vertical support and the third back panel plate on the shared vertical support; positioning a second back panel between the top and bottom shelf, such that that second back panel is aligned with second back panel plate on the second end vertical support and the third back panel plate on the shared vertical support; and securing the first back panel to the first back panel plate and securing the second back panel to the second back panel plate and the third back panel plate.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 is a perspective view of an exemplary back panel plate in accordance with the present disclosure.

FIG. 2 is a perspective view of the back panel bracket system installed on an exemplary storage structure having a first end vertical support and a second end vertical support in accordance with the present disclosure.

FIG. 3 is a fragmented, perspective view of the back panel bracket system installed on another exemplary storage structure having a first end vertical support, a second end vertical support, and a shared vertical support positioned between the end vertical supports in accordance with the present disclosure.

FIG. 4 is another perspective view of the back panel bracket system on the exemplary storage system of FIG. 3.

FIG. 5 illustrates a flow diagram detailing the steps of the present method.

### DETAILED DESCRIPTION OF THE INVENTION

While the present disclosure may be described with respect to specific applications or industries, those skilled in the art will recognize the broader applicability of the disclosure.

Those having ordinary skill in the art will recognize the terms such as “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The following discussion and accompanying figures disclose a back panel bracket system. While the back panel bracket system is illustrated and described herein for securing inset back panels to vertical supports in applications such as closets, cabinets, and similar storage systems, it will be understood that the back panel bracket system may be used for a variety of storage fixtures such as, but not limited to, vanities, shelves, and drawers, and for use in any desired location including, but not limited to, garages, bathrooms, kitchens, rooms within residential and/or business settings, or the like. Additionally, although the system is depicted as securing an inset back panel to vertical supports, it should be understood that the bracket system can be applied to any substantially vertical surface where a flush, inset attachment is desired, ensuring proper alignment and gap-free installation, as described herein.

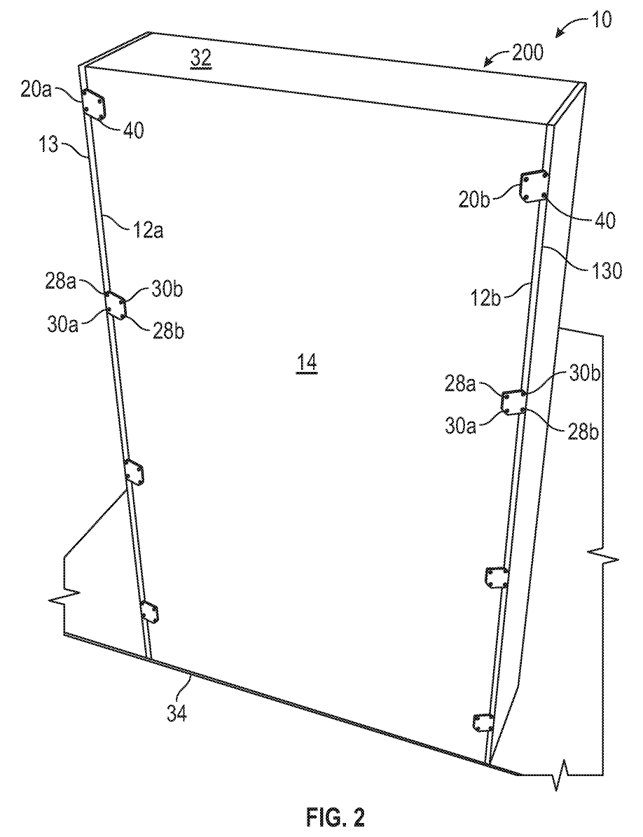

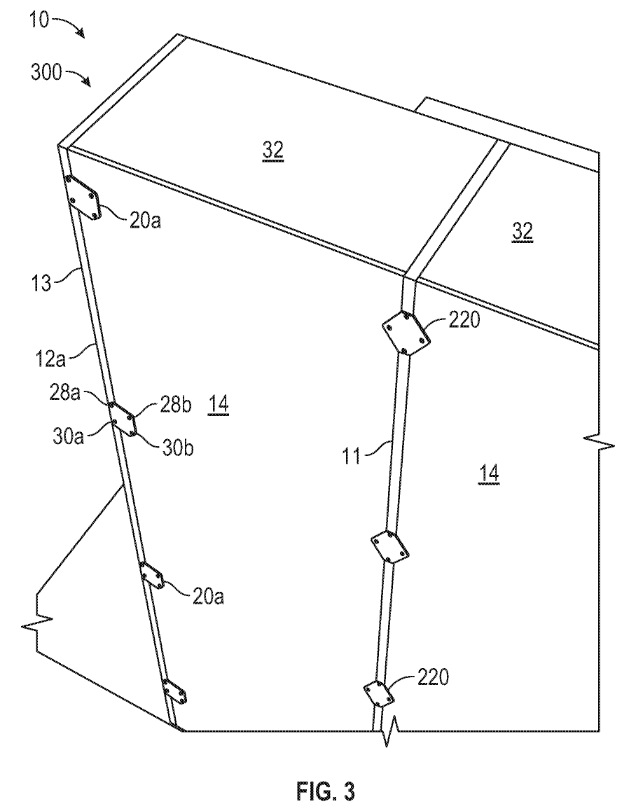

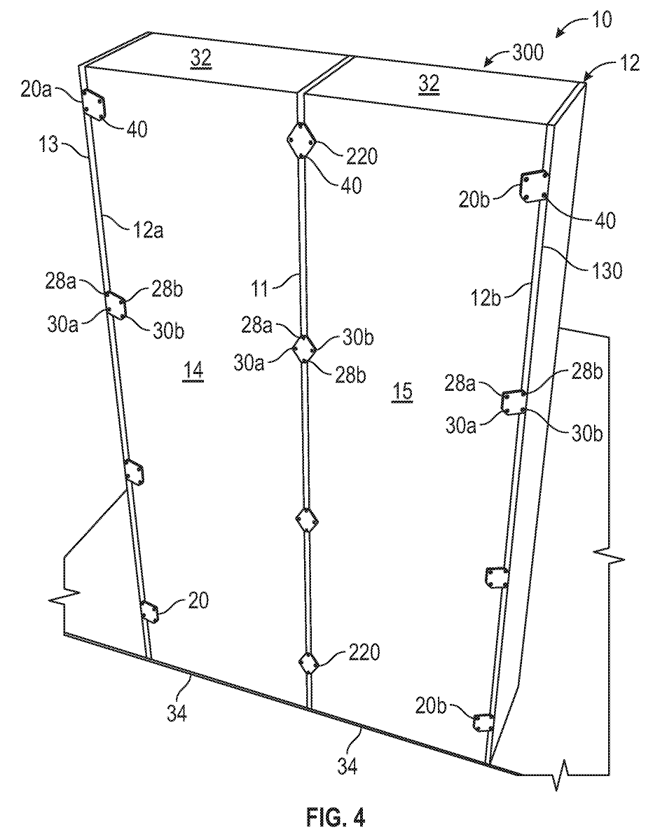

In a general sense, the back panel bracket system 10 of the present disclosure is designed for the efficient and secure installation of inset back panels in closets, cabinets, and other storage systems. More particularly, the back panel bracket system 10 may comprise one or more back panel plates 20a, 20b, 220, one or more end vertical supports, namely a first vertical end support 12a and a second vertical end support 12b, and one or more back panels 14 (FIG. 2). Optionally, the back panel bracket system 10 may also include one or more shared vertical supports 11 (FIGS. 3 and 4). The back panel plate 20a, 20b, 220 of the present disclosure is configured to align and fasten inset back panels 14 to both end vertical supports 12a, 12b located at the outer edges of the storage structure, and shared vertical supports 11, positioned between adjacent sections of the structure. The unique design of the plate 20a, 20b, 220 ensures that the apertures are centered on the vertical supports, providing a precise, gap-free fit between the inset back panel 14 and the vertical supports 11, 12a, 12b even in the presence of irregularities in wall surfaces. Additionally, the plate 20a, 20b, 220 allows for consistent, flush installation of the inset back panel 14, regardless of whether it is attached to shared vertical support 11 or end vertical supports 12a, 12b simplifying the installation process and reducing the number of components required. This system 10 ensures stability and a professional, clean finish in the final assembly.

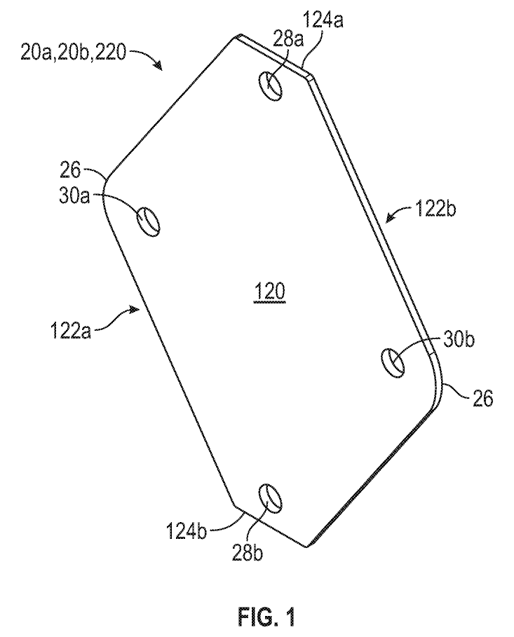

More particularly, referring now to the drawings, wherein like reference numerals refer to like components throughout the several views, FIGS. 1-4 show a back panel bracket system 10 of the present disclosure as depicted on storage structures 200 (FIG. 2) and 300 (FIGS. 3 and 4). More specifically, as depicted in FIG. 2, storage structure 200 includes two end vertical supports, namely a first end vertical support 12a and a second end vertical support 12b, and one back panel 14 secured thereto via back panel plates 20a, 20b. Storage structure 300, as depicted in FIGS. 3 and 4, includes two end vertical supports 12a, 12b and a shared vertical support 11 positioned between the end vertical supports 12a, 12b, with one or more back panels 14 secured via back panel plates 20a, 20b, 220. Back panel plates 20a, 20b are configured as mounting hardware for securing inset back panels 14 to end vertical supports 12a, 12b, and back panel plates 220 are configured as mounting hardware for securing inset back panels 14 to shared vertical supports 11.

For the sake of brevity, the back panel bracket system 10 is described in the context of a storage structure utilizing a back panel plate 20a applied to end vertical support 12a, a back panel plate 20b applied to end vertical support 12b, and a back panel plate 220 applied to a shared vertical support 11, although it will be understood that the storage system may include only one type of vertical support, one or more end vertical supports 12a, 12b or one or more shared vertical supports 11. Furthermore, it is understood that the storage structure may include one or more plates 20a along the first vertical support 12a (four plates 20a shown in FIGS. 2-4), one or more plates 20b along the second vertical support 12b (four plates 20b shown in FIGS. 2 and 4), and one or more plates 220 along the shared vertical support 11 (four plates 220 shown in FIGS. 3-4) depending on the specific installation requirements.

Referring specifically now to the back panel plate 20a, 20b, 220 of the back panel bracket system 10 as depicted in FIG. 1, the back panel plate 20a, 20b, 220 may be formed of a metallic material, a polymeric material, or any other suitable material or combinations of material. For example, if the back panel plate 20a, 20b, 220 is comprised of a metallic material, such a metallic material may be selected from an aluminum-based material, a steel-based material, an alloy, or any combination thereof or the like. Moreover, the back panel plate 20a, 20b, 220 may be powder coated, electrophoretic coated, plated, painted, stained, or otherwise finished and/or treated using common methods known to individuals skilled in the relevant art. In one non-limiting example, the back panel plate 20a, 20b, 220 is constructed of mild steel and treated with an electrophoretic coating.

Furthermore, the back panel plate 20a, 20b, 220 may be formed by injection molding, extrusion, die casting, stamping, machining, or otherwise manufactured using common methods known to individuals skilled in the relevant art, with respect to the respective material thereof. The above examples are not intended to be limiting in any matter, as it will be understood that the materials and/or methods used to form the back panel plate 20a, 20b, 220 may vary based on the intended use of the back panel bracket system 10, the location of installation, as well as the overall dimensions of the system 10.

Referring again to FIG. 1, more specifically, the back panel plate 20a, 20b, 220 comprises a body 120 having first and second long edges 122a, 122b and oppositely disposed first and second short edges 124a, 124b. The long edges 122a, 122b are bent in an outward direction to form wing portions 26, which extend from the body 120 of the back panel plate 20a, 20b, 220. The back panel plate 20a, 20b, 220 may include a plurality of apertures 28a, 28b, 30a, 30b arranged in a predetermined arrangement to facilitate secure attachment of the back panel plate 20a, 20b, 220 to the end vertical supports 12a, 12b (FIGS. 2-4) and the back panel plate 220 to the shared vertical supports 11 (FIGS. 3-4).

More particularly, a plurality of short edge apertures 28a, 28b may be positioned along the length of the opposing short edges 124a, 124b, substantially at or near the midpoint thereof. The plurality of short edge apertures may include a first aperture 28a positioned at or near the midpoint of the first short edge 124a and a second aperture 28b positioned at or near the midpoint of the second short edge 124b. Moreover, the back panel plate 20a, 20b, 220 may include a plurality of wing portion apertures 30a, 30b positioned along the length of the long edges 122a, 122b, substantially at or near the midpoint thereof within the wing portions 26. The plurality of wing portion apertures may include a third aperture 30a positioned within the wing portion 26 of the first long edge 122a and a fourth aperture 30b positioned within the wing portion 26 of the second long edge 122b. When the back panel plate 220 is utilized to secure shared vertical supports 11 to back panels 14, the positioning of the apertures 28a, 28b on the opposing short edges 124a, 124b allows for easy alignment and secure fastening of the back panel plate 220 to the shared vertical supports 11. Further, the positioning of the apertures 30a, 30b on the respective long edges 122a, 122b, i.e., within the wing portions 26, help center and secure the back panel plate 220 to back panel 14. Likewise, when a back panel plate 20a, 20b is utilized to secure end vertical supports 12a, 12b to back panels 14, the positioning of the apertures 28a, 28b on the opposing short edges 24a, 24b allow for easy alignment and secure fastening of the plate 20a, 20b to both the end vertical support 12a, 12b and back panel 14. Similarly, the positioning of the apertures 30a, 30b on long edges 122a, 122b, i.e., within the wing portions 26, also help center and secure the back panel plate 20a, 20b to both the end vertical support 12a, 12b and back panel 14.

The plurality of apertures 28a, 28b, 30a, 30b may be configured to receive a plurality of fastening features 40 such that the plurality of fastening features 40 is configured to secure the back panel 14 to the end vertical supports 12a, 12b via the back panel plate 20a, 20b and further configured to secure the back panel 14 to the shared vertical supports 11 via the back panel plate 220. While fastening features may be depicted as screws, it will be appreciated that other suitable means may be utilized as necessary to achieve the desired result of the installer within view of the present teachings. Furthermore, it is contemplated that the suitable fastener means may be formed of any suitable material including, but not limited to, a metallic material. Lastly, it is contemplated that the corresponding apertures 28a, 28b, 30a, 30b may be threaded or otherwise adapted to receive the corresponding fastener in a secure manner.

Next, an exemplary method 100 of securing a back panel 14 to vertical supports 11, 12a, 12b via the back panel bracket system 10 of the present disclosure is described and illustrated in FIGS. 2-5. Generally, the method 100 fixes the back panel plates 20a, 20b, 220 to the vertical supports 11, 12a, 12b, positions and secures the top and bottom shelves 32, 34, and then positions and secures the back panels 14, after which any intermediate shelves may be inserted. While the exemplary method 100 describes attachment of one or more back panel plates 20a, 20b to end vertical supports 12a, 12b and back panel plates 220 to shared vertical supports 11, it is contemplated that the storage structure may consist of only end vertical supports 12a, 12b without shared vertical supports 11, and the method may be applied accordingly.

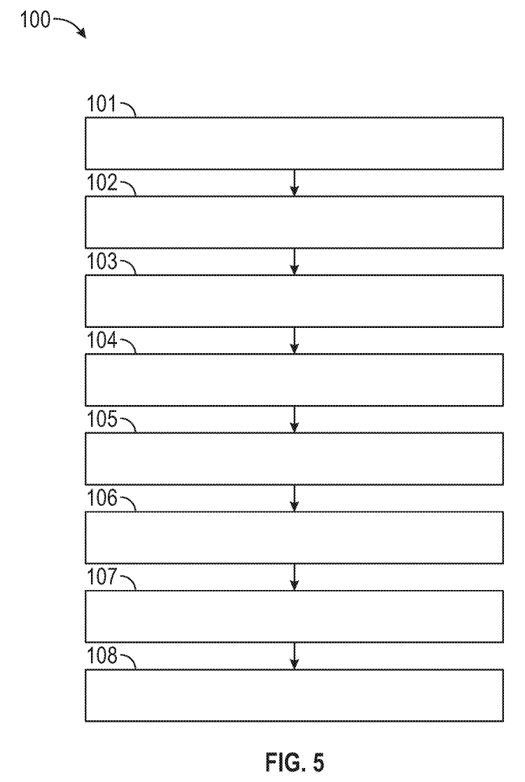

More particularly, as referring now to steps 101-108 of FIG. 5, the back panel bracket system 10 is configured to securely attach an inset back panel 14 to one or more end vertical supports 12a, 12b, and/or one or more shared vertical supports 11 via a universal back panel plate 20a, 20b, 220, thereby reducing the number of component parts required to assemble a storage structure 200, 300.

Referring first to the installation of the back panel bracket system 10 at step 101, the back panel bracket system 10 is provided as described herein. At step 102, a back panel plate 20a is aligned with the first end vertical support 12a, such that short edge 124a and the wing portion 26 of long edge 122a of the plate 20 are vertically aligned with respect to the outside edge 13 of the first end vertical support 12a. Moreover, as depicted in FIGS. 2 and 4, in this orientation, the first aperture 28a along the short edge 124a and third aperture 30a within the wing portion 26 of the long edge 122a, are properly positioned to be centered on the end vertical support 12a, ensuring precise placement of the plate 20a to both the end vertical support 12a via the first aperture 28a and the third aperture 30a and the back panel 14 via the second aperture 28b and the fourth aperture 30b.

Next, at step 103, the back panel plate 20a is secured or fastened to the first end vertical support 12a via a plurality of fastening features 40. The fastening features 40 are received through the corresponding first and third apertures 28a, 30a, respectively. More particularly, as depicted in FIGS. 2 and 4, a fastening feature 40 is received through the first aperture 28a located on the short edge 124a of the back panel plate 20a and a fastening feature 40 is received through the third aperture 30a located within the wing portion 26 of the long edge 122a, to secure the back panel plate 20a to the first end vertical support 12a. In one example embodiment, the plurality of fastening features 40 are screws.

Where a second end vertical support 12b is present, the alignment step 102 and the securement step 103 are repeated using one or more second back panel plates 20b to secure a plate or plates to the second end vertical support 12b. In particular, the back panel plate 20b is aligned with the second end vertical support 12b such that short edge 124b and the wing portion 26 of long edge 122b are vertically aligned with respect to the outside edge 130 of the second end vertical support 12b. In this orientation, the second aperture 28b along the short edge 124b and the fourth aperture 30b within the wing portion 26 of the long edge 122b are positioned to be centered on the second end vertical support 12b. The plate 20b is then secured to the second end vertical support 12b via fastening features 40 received through second aperture 28b at the short edge 124b and fourth aperture 30b within the wing portion 26 of the long edge 122b.

Next, at step 104, attachment of a back plate 220 to a shared vertical support 11 is completed. Here, a third back panel plate 220 is aligned with a shared vertical support 11 such that the short edges 124a, 124b of the back panel plate 220 are used as guides to center the plate on the shared vertical support 11, while the wing portions 26 of the long edges 122a, 122b extend beyond either side of the shared vertical support 11.

At step 105, the back panel plate 220 is then secured or fastened to the shared vertical support 11 via a plurality of fastening features 40. The fastening features 40 are received through the corresponding plurality of apertures 28a, 28b. More particularly, as depicted in FIGS. 1 and 4, fastening features 40 are received through the first aperture 28a located on the short edge 124a of the back panel plate 220, and through the second aperture 28b located on the short edge 124b of the back panel plate 220 to secure the back panel plate 220 to the shared vertical support 11. In one example embodiment, the plurality of fastening features 40 are screws.

Next, at step 106, top shelves 32 and bottom shelves 34 of the storage structure 200, 300 are positioned horizontally between the first and second end vertical supports 12a, 12b and secured according to standard installation procedures known to those skilled in the relevant art. Installation of only the top and bottom shelves 32, 34 at this stage allows for easier access and alignment of the back panel 14 during subsequent steps, namely, step 107.

As such, at step 107, one or more back panels 14 are positioned between the installed top shelf 32 and bottom shelf 34, brought into contact with the previously fixed back panel plates 20a, 20b on the end vertical supports 12a, 12b previously fixed back panel plates 20a, 20b on the end vertical supports previously fixed back panel plates 220 on the shared vertical supports 11, and secured thereto.

For the shared vertical support 11, the back panel 14 is coupled to the plate 220 via fastening features 40 received through the third aperture 30a and the fourth aperture 30b positioned within the wing portions 26. For first end vertical supports 12a, the first back panel plate 20a bears against the back panel 14, and the back panel 14 is coupled to the plate 20a via fastening features 40 received through the second aperture 28b and the fourth aperture 30b. For second vertical end supports 12b, the second back panel plate 20b bears against the back panel 14, and the back panel 14 is coupled to the plate 20b via fastening features 40 received though the first aperture 28a and the third aperture 30a. In a two-panel installation, as depicted in FIGS. 3 and 4, a first back panel 14 is disposed between the first end vertical support 12a and the shared vertical support 11 and is coupled to the first back panel plate 20a at the second aperture 28b and the fourth aperture 30b and the third back panel plate 220 at the third aperture 30a. The second back panel 15 is disposed between the second end vertical support 12b and the shared vertical support 11 and is coupled to the second back panel plate 20b at the first aperture 28a and the third aperture 30a, and the third back panel plate 220 at the fourth aperture 30b, after which both panels 14, 15 are secured. Where multiple shared vertical supports 11 are present, a corresponding number of back panels 14 are positioned and secured between adjacent shared supports so that each span between shared supports receives a back panel 14. The back panel(s) 14, 15 are then adjusted, as needed, to ensure they sit flush against the back panel plates 20a, 20b, 220, thereby providing a secure, gap-free fit with the vertical supports 11, 12a, 12b. Completion of step 107 positions and stabilizes the back panel(s) 14 within the storage structure 200, 300.

Lastly, at step 108, any remaining middle shelves (not depicted) are optionally installed.

In the manner described above, the back panel bracket system 10 of the present teachings allows for efficient, secure, and precise installation of inset back panels 14, 15. The system 10 reduces the number of component parts required, ensures proper alignment of the screw holes on both end and shared vertical supports, and provides a gap-free fit for a variety of storage systems, including closets, cabinets, and other applications.

With regard to the processes, systems, methods, heuristics, etc. described herein, it should be understood that, although the steps of such processes, systems, methods, heuristics, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

### LISTING OF REFERENCE NUMERALS

10 Panel Bracket System

11 Shared Vertical Supports

12a First End Vertical Supports

12b Second End Vertical Supports

13 Outside Edge of End Vertical Supports

14 Back Panel

15 Second Back Panel

20, 20b, 220 Back Panel Plate

120 Body of Back Panel Plate

122a First Long Edge of Back Panel Plate

122b Second Long Edge of Back Panel Plate

124a First Short Edge of Back Panel Plate

124b Second Short Edge of Back Panel Plate

26 Wing Portion

28a First Aperture

28b Second Aperture

30a Third Aperture

30b Fourth Aperture

32 Top Shelves

34 Bottom Shelves

40 Fastening Features

200, 300 Storage Structures

What is claimed is:

1. A panel bracket system for securing at least one back panel to at least one vertical support in a storage structure, comprising:
at least one vertical support;
one or more back panel plates, further comprising:
a plate body having a plurality of edges, wherein the plurality of edges further comprises:
a first short edge opposite a second short edge; and
a first long edge and a second long edge, each of the first long edge and the second long edge comprises a wing portion extending in an outward direction from the plate body;
wherein at least one back panel is coupled to the at least one vertical support via the one or more back panel plates.

2. The panel bracket system of claim 1, wherein the plate body of each of the one or more back panel plates further defines:
a plurality of short edge apertures comprising a first aperture positioned at a midpoint of the first short edge and a second aperture positioned at a midpoint of the second short edge; and
a plurality of wing portion apertures comprising a third aperture positioned within the wing portion of the first long edge of the back panel plate and a fourth aperture positioned within the wing portion of the second long edge of the back panel plate.

3. The panel bracket system of claim 2, wherein:
the one or more back panel plates comprise a first back panel plate and a second back panel plate;
the at least one vertical support comprises a first end vertical support and a second end vertical support; and
the first back panel plate is configured to couple the at least one back panel to the first end vertical support and the second back panel plate is configured to couple the at least one back panel to the second end vertical support.

4. The panel bracket system of claim 3, wherein:
the back panel extends from the first end vertical support to the second end vertical support;
the at least one back panel is coupled to the first back panel plate via the first end vertical support; and
the at least one back panel is further coupled to the second end vertical support via the second back panel plate.

5. The panel bracket system of claim 4, wherein:
the first back panel plate is coupled to the first end vertical support and the at least one back panel via a first plurality of fastening features, wherein one of the first plurality of fastening features is received through the first aperture and another of the first plurality of fastening features is received through the third aperture; and
the first aperture and the third aperture of the first back panel plate are aligned with an outside edge of the first end vertical support.

6. The panel bracket system of claim 5, wherein:
the second back panel plate is coupled to the second end vertical support and the at least one back panel via a second plurality of fastening features, wherein one of the second plurality of fastening features is received through the second aperture and another of the second plurality of fastening features is received through the fourth aperture; and
the second aperture and the fourth aperture of the second back panel plate are aligned with an outside edge of the second end vertical support.

7. The panel bracket system of claim 6, wherein each of the fastening features of the first plurality of fastening features and the second plurality of fastening features is a screw.

8. The panel bracket system of claim 1, wherein the one or more back panel plates are formed of an e-coated steel material.

9. The panel bracket system of claim 2, wherein:
the at least one vertical support comprises a first end vertical support, a second end vertical support, and a shared vertical support positioned between the first end vertical support and the second end vertical support;
the one or more back panel plates comprises a first back panel plate, a second back panel plate, and a third back panel plate; and
the at least one back panel comprises a first back panel configured to be coupled to the first end vertical support via the first back plate and the shared vertical support via the third back plate and a second back panel configured to the coupled to the shared vertical support via the third back plate and the second end vertical support via the second back plate.

10. The panel bracket system of claim 9, wherein the first back panel is disposed between the first end vertical support and the shared vertical support and is coupled to the first back panel plate and the third back panel plate, and the second back panel is disposed between the second end vertical support and the shared vertical support and is coupled to the second back panel plate and the third back panel plate.

11. The panel bracket system of claim 10, wherein:
the first back panel plate is secured to the first end vertical support and the first back panel via a first plurality of fastening features, wherein one of the first plurality of fastening features is received through first aperture and another of the first plurality of fastening features is received through the third aperture;
the second back panel plate is secured to the second end vertical support and the second back panel via a second plurality of fastening features, wherein one of the second plurality of fastening features is received through the second aperture and another of the second plurality of fastening features is received through the fourth aperture; and
the third back panel plate is secured to the shared vertical support via a third plurality of fastening features, wherein one of the third plurality of fastening features is received through the first aperture and another of the third plurality of fastening features is received through the second aperture.

12. The panel bracket system of claim 11, wherein each of the first back panel and the second back panel is coupled to the third back panel plate via the third plurality of fastening features, and wherein one of the third plurality of fastening features is received through the third aperture of the third back panel plate thereby coupling the third back panel plate to the first back panel, and another of the third plurality of fastening features is received through the fourth aperture thereby coupling the third back panel plate to the second back panel.

13. The panel bracket system of claim 12, wherein each of the fastening features of the third plurality of fastening features is a screw.

14. A method of securing a back panel to one or more vertical supports in a storage structure, the method comprising:
providing a plurality of back panel plates adapted to secure the back panels to the vertical supports, the back panel plates comprising:
a first back panel plate, a second back panel plate and a third back panel plate, each having a first short edge opposite a second short edge, a first long edge, and a second long edge, wherein each long edge comprises a wing portion, and each plate defining a plurality of short-edge apertures including a first aperture and a second aperture and a plurality of wing-portion apertures including a third aperture and a fourth aperture;
positioning the first back panel plate in contact with a first end vertical support; and
securing the first back panel plate to the first end vertical support via a first plurality of fastening features, wherein one of the first plurality of fastening features is received through the first aperture and another of the first plurality of fastening features is received through the third aperture.

15. The method of claim 14, further comprising:
positioning the second back panel plate in contact with a second end vertical support; and
securing the second back panel plate to the second end vertical support via a second plurality of fastening features, wherein one of the second plurality of fastening features is received through the second aperture and another of the second plurality of fastening features is received through the fourth aperture.

16. The method of claim 15, further comprising:
positioning a shared vertical support between the first and second end vertical supports; and
securing the third back panel plate to the shared vertical support via a third plurality of fastening features, wherein one of the third plurality of fastening features is received through the first aperture and another of the third plurality of fastening features is received through the second aperture.

17. The method of claim 16, further comprising:
installing a top shelf and a bottom shelf to the first and second end vertical supports and the shared vertical support, wherein the top shelf and bottom shelf are positioned horizontally between the first and second end vertical supports;
positioning a first back panel between the top shelf and the bottom shelf, such that the first back panel is aligned with the first back panel plate on the first end vertical support and the third back panel plate on the shared vertical support; and
positioning a second back panel between the top and bottom shelf, such that that second back panel is aligned with second back panel plate on the second end vertical support and the third back panel plate on the shared vertical support.

18. The method of claim 17, further comprising:
securing the first back panel to the first back panel plate via the first plurality of fastening features, wherein one of the first plurality of fastening features is received through the second aperture and another of the first plurality of fastening features is received through the fourth aperture;
securing the second back panel to the second back panel plate via the second plurality of fastening features, wherein one of the second plurality of fastening features is received through the first aperture and another of the second plurality of apertures is received through the third aperture; and
securing the first back panel and the second back panel to the third back panel plate via the third plurality of fastening features, wherein one of the third plurality of fastening features is received through the third aperture thereby coupling the third back panel plate to the first panel and another of the third plurality of fastening features is received through the fourth aperture thereby coupling the third back panel plate to the second panel.

19. The method of claim 18, wherein each of the fastening features of the first plurality of fastening features, the second plurality of fastening features, and third plurality of fastening features is a screw.

20. The method of claim 14, wherein each of the first back panel plate, the second back panel plate, and the third back panel plate are formed of an e-coated steel material.
